(19) United States
(12) Patent Application Publication
(10) Pub. No.: US 2003/0187657 A1
(43) Pub. Date: Oct. 2, 2003

(54) Voice control of streaming audio

(76) Inventors: George W. Erhart, Pataskala, OH (US); Stephen C. Griffiths, Westerville, OH (US); David J. Skiba, Columbus, OH (US); Daniel S. Stoops, Galena, OH (US)

Correspondence Address: Patrick D. Floyd, FAY, SHARPE, FAGAN, MINNICH & McKEE, LLP, Seventh Floor, 1100 Superior Avenue, Cleveland, OH, 44114-2518, US

(21) Appl. No.: 10/106,408

(22) Filed: Mar. 26, 2002

(51) Int. Cl. G10L 21/00

(52) U.S. Cl. 704/270.1

(57) ABSTRACT

A method of controlling the flow of streaming audio is provided. The method includes providing an application for receiving streaming audio and for controlling which streaming audio is sent to the user. The method also includes receiving voice commands, categorizing the voice commands as an interrupt-type commands or a streaming-type commands, performing interrupt-type control actions associated with the interrupt-type commands for controlling which streaming audio is provided to the user, and performing streaming-type control actions associated with the streaming-type commands for altering the streaming audio sent to the user without interrupting the streaming audio received by the application. The invention includes an interactive voice recognition system for controlling the flow of streaming audio to a user.

### BACKGROUND OF THE INVENTION

The present invention relates to voice control of information flow and more particularly to an audio portal providing interactive voice control of streaming audio.

As our lifestyle becomes increasingly more mobile, people are looking for more convenient ways to access information. They want specific, current information readily available wherever they go. With the advent of cellular telecommunications, a large portion of the population has access to mobile communication devices which may provide a viable solution to our information needs. The Internet offers a tremendous volume and variety of information, but the options for accessing the Internet are limited and not well suited for the mobile lifestyle.

Speech recognition systems have been used in connection with telephones to provide an interactive interface for users to accomplish a variety of tasks. Examples of such task-based applications include customers accessing systems which enable them to buy merchandise or services simply by speaking instructions into the phone. These previous task-based applications have included speech recognition and streaming audio as separate entities, using a prompt-and-collect routine to play audio prompting the user to provide spoken information and collecting the spoken information from the user. Speech recognition interprets the user's spoken responses and determines which utterances are equated with control actions for providing interactive control of the flow of information.

Users typically want a speech recognition system which appears to be intelligent. In the past, system intelligence has been associated with the speech recognition system's ability to provide a quick response to a spoken command. Control is quickly passed from the user to the system as soon as a spoken command equated with a control action is detected. These prompt-and-collect systems, also referred to as “barge-in” systems, react to voice commands by stopping the audio stream as soon as possible after recognizing the voice command to appear responsive. The recognized utterance is then further processed to achieve the associated control action for changing the message flow accordingly. However, interrupting the streaming audio can impair the performance of the system during some control events.

It is desirable to provide a speech recognition system which allows for smoother operation and more flexibility in controlling the flow of information using voice commands.

### SUMMARY OF THE INVENTION

In accordance with a first aspect of the invention, a method of controlling the flow of streaming audio media is provided. The method includes providing an application for receiving streaming audio and for controlling which streaming audio is provided to a user. The method also includes receiving voice commands, categorizing the voice commands as an interrupt-type commands or a streaming-type commands, performing interrupt-type control actions associated with the interrupt-type commands for controlling which streaming audio is provided to the user, and performing streaming-type control actions associated with the streaming-type commands for altering the streaming audio sent to the user without interrupting the streaming audio received by the application.

In accordance with a second aspect of the invention, an audio portal for providing streaming audio media is provided. The audio portal can include an input/output device for communicating with a user to receive voice commands from the user and send streaming audio media to the user. The audio portal includes speech recognition means for categorizing the voice commands as interrupt-type commands. The audio portal also includes an application for receiving streaming audio and performing interrupt-type control actions associated with the interrupt-type commands for controlling which streaming audio is provided to the user. The audio portal also includes a streaming controller for performing streaming-type control actions associated with the streaming-type commands for altering the streaming audio sent to the user without interrupting the streaming audio received by the application.

In accordance with yet another aspect of the invention, an interactive voice recognition system for controlling the flow of streaming audio media to a user. The interactive voice recognition system includes speech recognition means for categorizing user voice commands as interrupt-type commands or streaming-type commands. The interactive voice recognition system also includes an application for receiving streaming audio and performing interrupt-type control actions associated with the interrupt-type commands for controlling which streaming audio is provided to the user. The interactive voice recognition system also includes a streaming controller for performing streaming-type control actions associated with the streaming-type commands for altering the streaming audio sent to the user without interrupting the streaming audio received by the application.

### BRIEF DESCRIPTION OF THE DRAWINGS

The invention may take form in certain components and structures, preferred embodiments of which will be illustrated in the accompanying drawings wherein:

FIG. 1 is a block diagram illustrating the invention;

FIG. 2 is a block diagram illustrating an embodiment of the invention;

FIG. 3 is a block diagram illustrating an embodiment of the invention; and

FIG. 4 flow diagram illustrating the performance of the speech recognition system in accordance with the invention.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting.

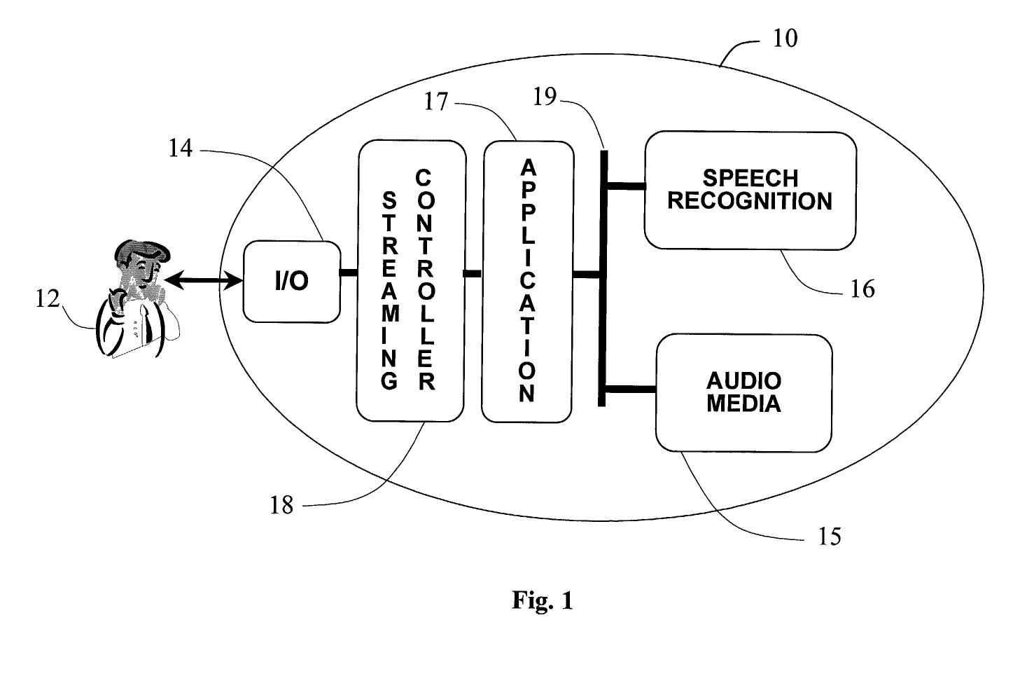

Referring now to FIG. 1, an audio portal is shown generally at 10. The audio portal 10 communicates with a user 12 to provide the user with interactive voice control of streaming audio media. The audio portal 10 can include an Input/Output (I/O) device 14 for communicating with the user 12 to receive voice commands from the user and to send streaming audio media, shown generally at 15, to the user in any suitable known manner.

The audio portal 10 also includes a speech recognition module 16 for interpreting the user's spoken responses and determining which utterances are equated with control actions are intended to provide interactive control of the flow of information. The speech recognition module 16 categorizes the user's voice commands into at least two categories including interrupt-type commands for performing interrupt-type control actions as shall be described in further detail below, and streaming-type commands for performing streaming-type control actions as shall be described in further detail below.

The audio portal 10 also includes an application 17 for receiving audio media 15 and controlling what audio media is sent to the user 12. The application includes control logic necessary to run prompt-and-collect routines to prompt the user to provide spoken information and collecting the spoken information to control which streaming audio is provided to the user. The application 17 provides user preference provisioning which allows the application to be tailored to the specific needs of the user as shall be described in further detail below. The interrupt-type control actions are typically performed by the application 17 for controlling what streaming audio media is sent to the user 12 via the I/O device 14 in accordance with user's preferences.

The streaming-type commands are sent to a streaming audio controller 18 which performs streaming-type control actions to alter the audio media while it is streaming without interruption as shall be described in further detail below. The application 17, streaming controller 18, and speech recognition module 16 communicate over any suitable known communication link such as for example an Ethernet connection 19.

The audio portal 10 may provide the user 12 with access to the Internet as described below, or another conventional intermediate network. Alternatively, the audio portal 10 may be used as an interactive interface for controlling the flow of audio information to/from a stand-alone system, such as phone based merchandise sales system, a banking transaction system, or any other known task-based application.

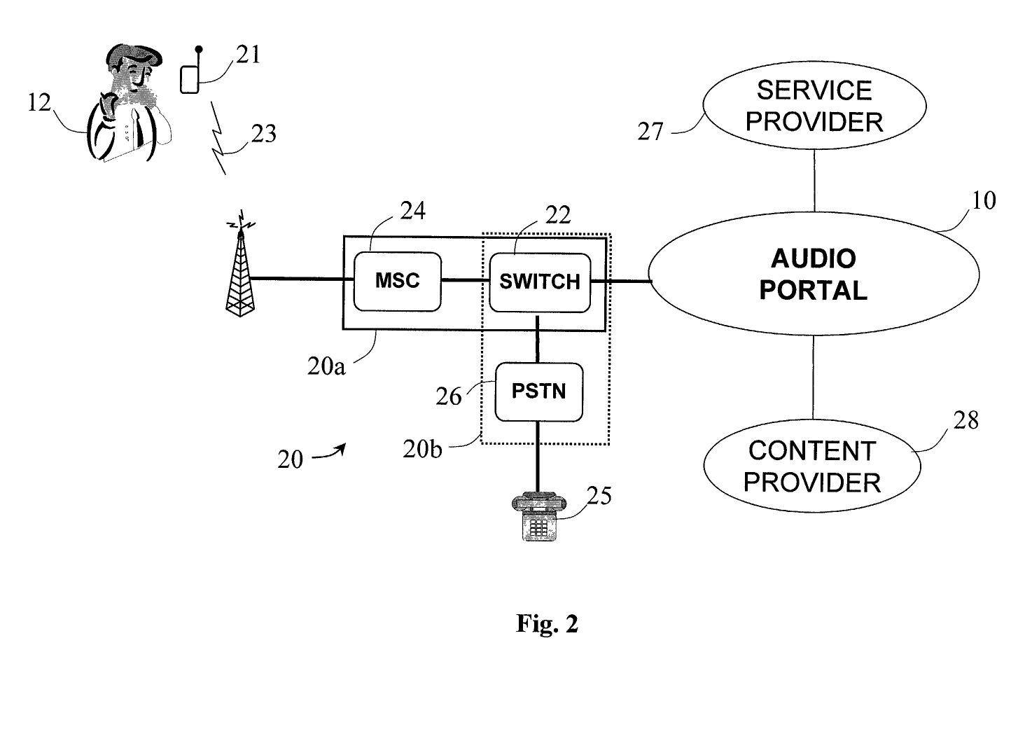

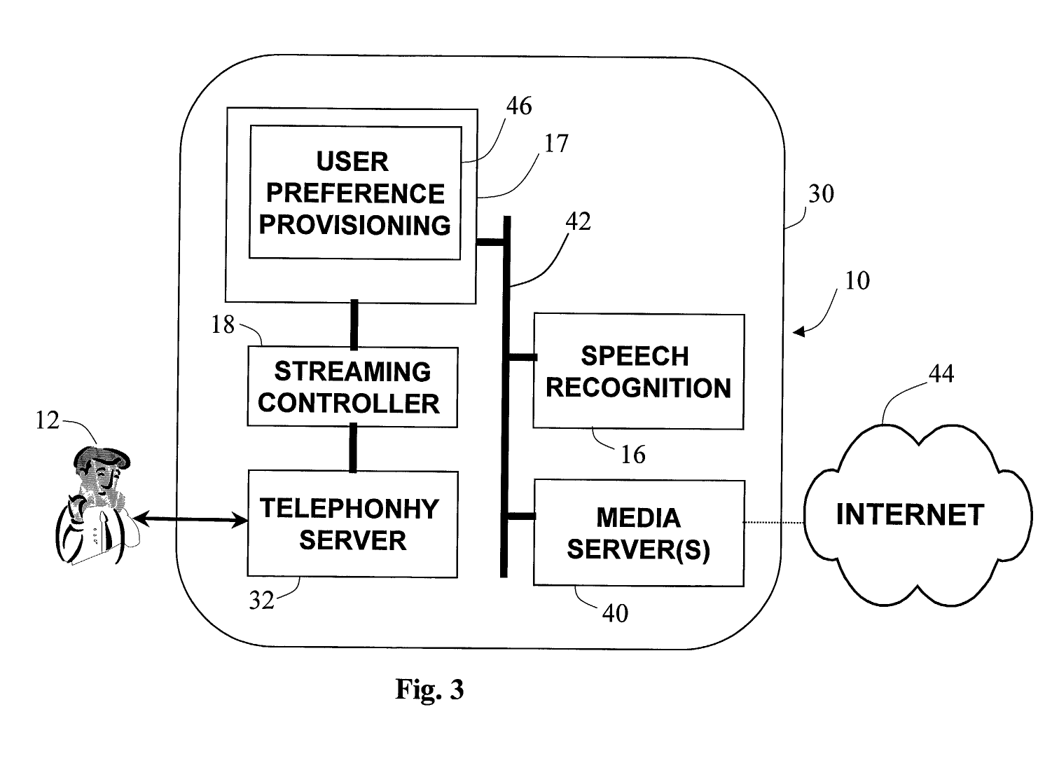

Referring now to FIGS. 2 and 3, an embodiment of the invention is described in which the user 12 communicates with the audio portal 10 over a known telephony system shown generally at 20. The telephony system 20 can be any suitable mobile telephony system 20a. An example, which should not be considered limiting, of a mobile telephony system 20a includes a mobile telephone 21 connected to the audio portal 10 over a wireless interface 23 via a known mobile switching center 24 and telephone switch 22. Alternatively, telephony system 20 can be a land-based telephony system shown by the dotted box 20b including, for example, a conventional telephone 25 communicating with the portal 10 via the switch 22 and the Public Switched Telephone Network 26.

The audio portal 10 is preferably operated by a service provider 27 which provides and maintains the hardware and software needed for the operation of the audio portal. However, the audio portal may be integrated into any known device or system in which interactive user voice control of the flow of streaming audio media is desired.

As part of the preferred embodiment of the invention described herein, a separate content provider, shown generally at 28, provides the streaming audio media 15 from various sources including the Internet as shall be described in further detail below. However, it should be appreciated that in alternate embodiments of the invention the content provider 28 can be integrated into the service provider 27. Further in other alternate embodiments, the service/content provider can provide the audio information as part of an interactive voice recognition system for completing known tasks in a task-based application such the voice operated sales system described above.

In FIG. 3, the audio portal 10 is provided by a computing platform 30, such as a USC 1000 sold by Lucent, or any other suitable known computing/processing platform. The computer platform architecture can be based on a CompactPCI (cPCI) platform providing access based on cPCI standards, although any other suitable known architecture can be used. The computing platform 30 includes a known telephony server 32 operating as the I/O device 14 to communicate with the user 12 for receiving voice commands from the user and sending streaming audio media to the user in any suitable known manner. The telephony server 32 provides a telephone interface (PSTN or PLMN), and supports signaling such as T1, E1 or any other known signaling via robbed-bit, ISDN, SS7, or any other known format.

The application 17 and streaming controller 18 controls the telephony server 32 in response to the user's voice commands as interpreted and categorized by the speech recognition module 16. The application 17 and streaming controller 18 can each take the form of any known processor or any known processing algorithm for performing the desired control actions as shall be described in further detail below.

The application 17 and streaming controller 18 can be separate from the telephony server 32 or integrated into the telephony server in any known manner. The telephony server 32 communicates with the speech recognition module 16, and a media server 40 over any suitable known communication link such as for example an Ethernet connection 42.

The media server 40 can be provided by a content provider 28 as described above. The media server 40 is preferably connected to the Internet 44 in a known manner for providing a wide variety of live or pre-recorded media 15 which is of interest to the user 12. Examples of such media include, but are not limited to, sports or music broadcasts, stock reports, news, weather, pre-recorded music, personal calendars, emails, advertising or any other desired information. The media server 40 enables the user 12 to access a variety of information in audio form which is available from a number of different known formats including but not limited to .wav files, MP3, text files, etc. The media server 40 formats the media into audio media for transmission to the user via the telephony server 32 in a known manner. The media server 40 can also include known text-to-speech processing for providing text-based content to the user in streaming audio form.

The audio portal 10 also includes user preference provisioning means 46, provided by the application 17, which can take the form of a server or any other known hardware or any known processing algorithm for customizing the application 17 in accordance with the user's preferences. The user 12 can customize the application 17, and thus the audio portal 10, to have the media server 40 play whatever kind of audio media the user desires. For example, the user 12 can generate play lists which include the media he/she wishes to receive and the order in which each audio track is provided. The user 12 can customize the application 17 using any known means, including voice commands, or written commands provided directly or via an Internet connection.

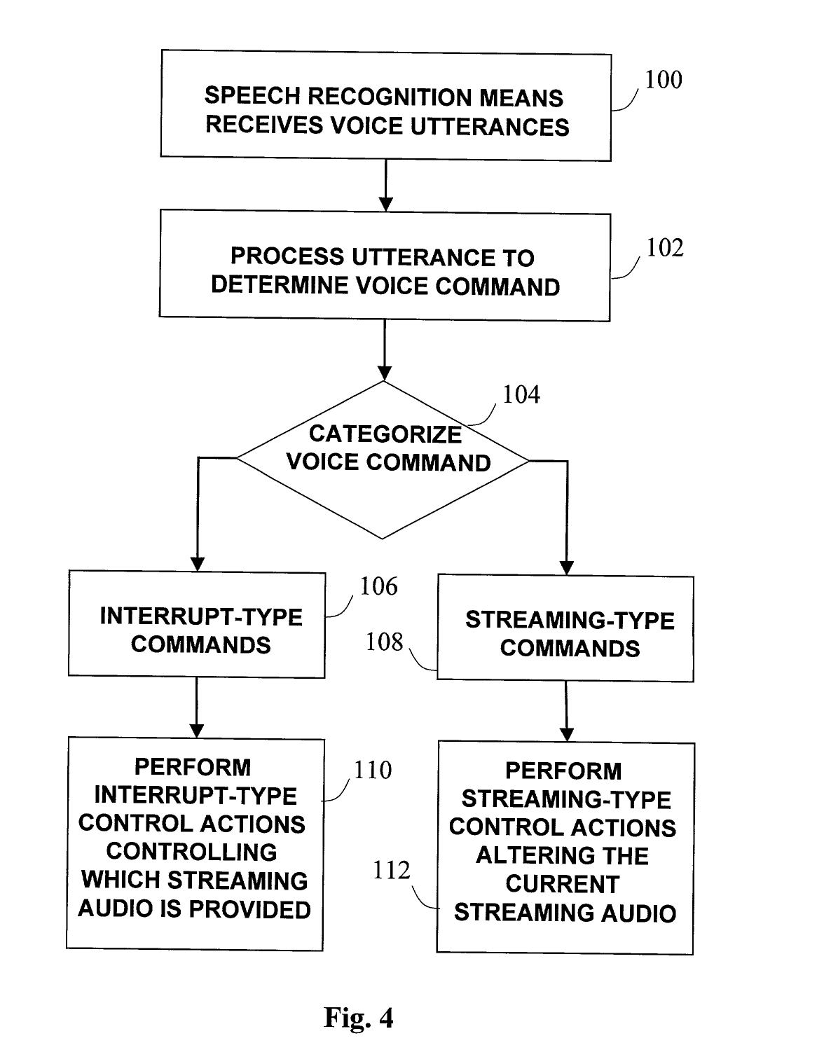

Referring now to FIG. 4, the invention enables the user 12 to seamlessly control the flow of streaming audio media from the audio portal 10 using speech recognition which categorizes the user's voice commands into two categories. While the audio media is streaming to the user, the speech recognition module 16 receives voice utterances from the telephony server 32 in a known manner at 100. The speech recognition module 16 can be configured to recognize speech in any known language as desired.

The telephony server 32 sends the voice information received from the user 12 to the speech recognition module 16 in any known manner. For example, the voice information can be sent in packets, typically containing at least a portion of an utterance or spoken word lasting for some predetermined period of time, such as for example 100 msec, though any time period may be used. The speech recognition module 16 uses any suitable known manner of speech recognition to process each packet for determining/recognizing voice commands at 102. Each packet may be processed individually or combined with other packets.

Upon recognizing a voice command, the speech recognition module 16 categorizes the command at 104 into at least two categories. Voice commands which result in control actions which interrupt the flow of streaming media to the application 17 are categorized as interrupt-type commands at 106. These commands are preferably handled by the application 17, which performs interrupt-type control actions associated with each interrupt-type command to control which streaming audio is provided to the user 12 at 110.

The application may perform known prompt-and-collect routines as described above. The prompt-and-collect routines interrupt the streaming audio media as soon as possible to appear responsive, prompting the user to provide spoken information and collecting the spoken information to control which streaming audio is provided by the application. The application 17 controls the platform 30 to perform the interrupt-type control action equated with the voice command in a known manner such as, for example, skipping to the next media track. Examples of interrupt-type control actions include, but are not limited to, skipping to the next streaming audio track, playing a particular streaming audio track, and stopping the streaming audio.

Voice commands which result in streaming-type control actions which do not interrupt the streaming audio media received by the application 17 are categorized as streaming-type commands at 108. Examples of such streaming-type commands include, but are not limited to, “louder”, “faster” and “forward”. These commands are preferably handled by the streaming controller 18 which performs streaming-type control actions altering the streaming audio sent to the user 12 without interrupting the streaming audio 15 received by the application 17. As a result, the invention provides the user 12 with interactive voice control of the streaming audio without interrupting the delivery of the streaming audio to the user. Streaming-type control actions can be any suitable known control actions which do not require interruption of the audio stream such as for example, increasing/decreasing the volume or the pace of the streaming audio.

To provide superior interactive control, the invention categorizes voice commands which can be equated with pausing and resuming the streaming audio media as streaming-type commands. Categorizing these commands in this manner results in implementing a true pause of the live audio stream. A true pause of the audio stream ensures that the audio stream is still received by the application 17 and thus not disconnected from the audio portal 10 during the pause duration. Resuming the audio stream results in near instantaneous continued play with no rebuffering delays. Whereas, treating pause and resume control actions as interrupt-type commands disconnects the audio stream from the application resulting in undesirable delays while reconnecting the stream when acting upon the resume command.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

We claim:

1. A method of controlling the flow of streaming audio comprising:
providing an application for receiving streaming audio and for controlling which streaming audio is provided to a user;
receiving voice commands;
categorizing the voice commands as an interrupt-type commands or a streaming-type commands;
performing interrupt-type control actions associated with the interrupt-type commands for controlling which streaming audio is provided to the user; and
performing streaming-type control actions associated with the streaming-type commands for altering the streaming audio sent to the user without interrupting the streaming audio received by the application.

2. The method of controlling the flow of streaming audio defined in claim 1 wherein the voice command is only a portion of an utterance.

3. The method of controlling the flow of streaming audio defined in claim 1 wherein the categorizing step further includes performing voice recognition to determine the voice command.

4. The method of controlling the flow of streaming audio defined in claim 1 wherein the interrupt-type control action includes performing a prompt-and-collect routine for prompting the user to provide spoken information and collecting the spoken information from the user.

5. The method of controlling the flow of streaming audio defined in claim 1 wherein the streaming-type control action changes the pace of flow of the streaming audio.

6. The method of controlling the flow of streaming audio defined in claim 1 wherein the streaming-type control action changes the volume of the streaming audio.

7. The method of controlling the flow of streaming audio defined in claim 1 wherein the streaming-type control action pauses the streaming audio sent to the user.

8. The method of controlling the flow of streaming audio defined in claim 1 wherein the interrupt-type control action sends a different track of streaming audio to the user.

9. An audio portal for providing streaming audio to a user comprising:
speech recognition means for categorizing user voice commands as interrupt-type commands or streaming-type commands;
an application for receiving streaming audio and performing interrupt-type control actions associated with the interrupt-type commands for controlling which streaming audio is provided to the user; and
a streaming controller for performing streaming-type control actions associated with the streaming-type commands for altering the streaming audio sent to the user without interrupting the streaming audio received by the application.

10. The audio portal defined in claim 9 further comprising an input/output device for communicating with the user to receive voice commands from the user and send streaming audio to the user.

11. The audio portal defined in claim 10 wherein the input/output device is a telephony server.

12. The audio portal defined in claim 9 further including a media server connected to the Internet for obtaining the streaming audio sent to the user.

13. The audio portal defined in claim 9 wherein the speech recognition means and application are part of a task-based application.

14. The audio portal defined in claim 9 wherein the application provides user preference provisioning to customize the streaming audio sent to the user in accordance with the user's preferences.

15. An interactive voice recognition system for controlling the flow of streaming audio to a user comprising:
speech recognition means for categorizing user voice commands as interrupt-type commands or streaming-type commands;
an application for receiving streaming audio and performing interrupt-type control actions associated with the interrupt-type commands for controlling which streaming audio is provided to the user; and
a streaming controller for performing streaming-type control actions associated with the streaming-type commands for altering the streaming audio sent to the user without interrupting the streaming audio received by the application.

16. The interactive voice recognition system defined in claim 15 further comprising an input/output device for communicating with the user to receive voice commands from the user and send streaming audio to the user.

17. The audio portal defined in claim 16 wherein the input/output device is a telephony server.

18. The interactive voice recognition system defined in claim 15 further comprising a media server connected to the Internet for obtaining the streaming audio sent to the user.

19. The interactive voice recognition system defined in claim 15 wherein the speech recognition means and application are part of a task-based application.

20. The interactive voice recognition system defined in claim 15 wherein the application provides user preference provisioning to customize the streaming audio sent to the user in accordance with the user's preferences.
